(19) United States
(12) Patent Application Publication
(10) Pub. No.: US 2023/0286247 A1
(43) Pub. Date: Sep. 14, 2023

(54) FIBER-REINFORCED RESIN BONDED STRUCTURE

(71) Applicant: SUBARU CORPORATION, Tokyo (JP)

(72) Inventor: Yuya MUKAINAKANO, Tokyo (JP)

(73) Assignee: SUBARU CORPORATION, Tokyo (JP)

(21) Appl. No.: 18/174,908

(22) Filed: Feb. 27, 2023

(30) Foreign Application Priority Data
Mar. 10, 2022 (JP) 2022-037432

(51) Int. Cl. B32B 5/10; B32B 7/14; B32B 3/30

(52) U.S. Cl. CPC B32B 5/10; B32B 7/14; B32B 3/30; B32B 2250/02; B32B 2605/00

(57) ABSTRACT

A fiber-reinforced resin bonded structure includes a first member, a second member, and an adhesive layer that bonds the first member and the second member. One or both of the first member and the second member are made of a fiber-reinforced resin composite. The adhesive layer includes at least one first region having a relatively large layer thickness and a second region having a relatively small layer thickness. The at least one first region of the adhesive layer includes a spacer in contact with the first member and the second member.

### CROSS-REFERENCE TO RELATED APPLICATIONS

The present application claims priority from Japanese Patent Application No. 2022-037432 filed on Mar. 10, 2022, the entire contents of which are hereby incorporated by reference.

### BACKGROUND

The disclosure relates to a fiber-reinforced resin bonded structure.

Recently, for the purpose of weight reduction of vehicles such as passenger vehicles, study has been made on manufacturing structural members of a vehicle body, such as a pillar and a side sill, using a fiber-reinforced resin that includes reinforcement fibers such as carbon fibers. The structural member made of the fiber-reinforced resin has high rigidity and, for example, exhibits a high strength against tensile stress applied in an orientation direction of fibers. The structural member made of the fiber-reinforced resin includes a structural member manufactured by bonding a composite made of the fiber-reinforced resin (fiber-reinforced resin composite) to another fiber-reinforced resin composite or a member made of metal via an adhesive layer.

In this manner, when two members (one or more of which are made of the fiber-reinforced resin composite as an adhered) are bonded to each other via the adhesive layer, a thickness of the adhesive layer affects an adhesive strength. Thus, control of the thickness of the adhesive layer is attracting attention. To deal with this issue, as described in, for example, Japanese Examined Patent Application Publication No. H07-51318, a method for controlling the thickness of the adhesive layer by using an adhesive in which a glass bead is mixed has been known.

### SUMMARY

An aspect of the disclosure provides a fiber-reinforced resin bonded structure including a first member, a second member, and an adhesive layer that bonds the first member and the second member. One or both of the first member and the second member are made of a fiber-reinforced resin composite. The adhesive layer includes at least one first region having a relatively large layer thickness and a second region having a relatively small layer thickness. The at least one first region of the adhesive layer includes a spacer in contact with the first member and the second member.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a cross-sectional view schematically illustrating a configuration example of a fiber-reinforced resin bonded structure according to an embodiment.

FIG. 2 is an enlarged cross-sectional view illustrating a part of the fiber-reinforced resin bonded structure according to the embodiment.

FIG. 3 illustrates an application example of the fiber-reinforced resin bonded structure according to the embodiment.

FIG. 4 illustrates an action of a destruction preventing member.

FIG. 5 illustrates another configuration example of a fiber-reinforced resin bonded structure according to the embodiment.

FIG. 6 illustrates another configuration example of a fiber-reinforced resin bonded structure according to the embodiment.

FIG. 7 illustrates a manufacturing process of a second member of a fiber-reinforced resin bonded structure according to the embodiment.

FIG. 8 illustrates a process of bonding a first member and the second member.

FIG. 9 illustrates a bonded structure in the related art using spacers.

### DETAILED DESCRIPTION

When a structure having a complicated three-dimensional shape, such as a structural member of a vehicle, is manufactured by bonding two members, one or more of which are made of a fiber-reinforced resin composite, it is difficult to control a distance between adhesive surfaces so as to be uniform. Therefore, in order to control a thickness of an adhesive layer, a glass bead having a large diameter is to be mixed with the adhesive layer, and thus the thickness of the adhesive layer may be increased. When the thickness of the adhesive layer is increased, an adhesive strength is likely to be lower than when the thickness of the adhesive layer is small. Since the adhesive strength is reduced, a crack starting from an interface between an adhesive and the glass bead is likely to occur, and the reliability of a bonded part may be reduced.

Therefore, it is desirable to improve an adhesive strength of a fiber-reinforced resin bonded structure that is obtained by bonding a first member and a second member, one or more of which are made of the fiber-reinforced resin composite.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. Fiber-Reinforced Resin Bonded Structure

### 1-1. Basic Configuration

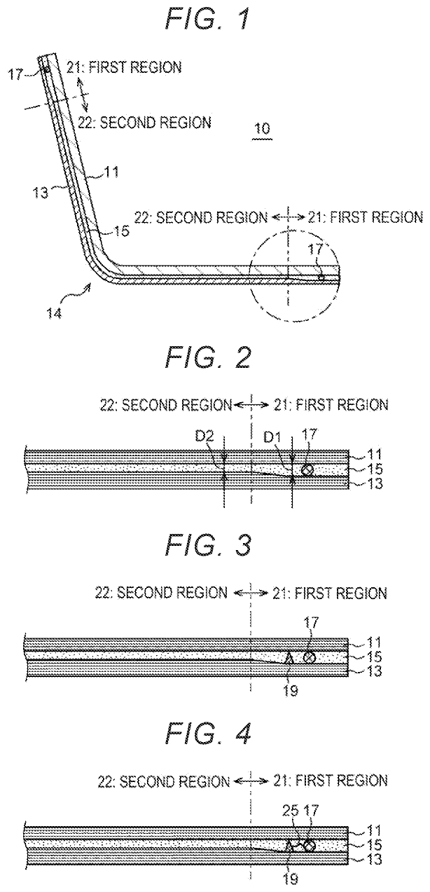

First, an example of a fiber-reinforced resin bonded structure (hereinafter, simply referred to as a “bonded structure”) according to an embodiment of the disclosure will be described. FIG. 1 is a cross-sectional view schematically illustrating a configuration example of a bonded structure 10. FIG. 2 is an enlarged cross-sectional view illustrating a region X surrounded by an alternate long and short dash line in the bonded structure 10 illustrated in FIG. 1.

The bonded structure 10 is applied to a structure that constitutes a vehicle body structure such as a front pillar, a center pillar, a rear pillar, a roof side rail, and a side sill. In many cases, the structure that constitutes the vehicle body structure has a complicated three-dimensional shape, and it is difficult to control a thickness of an adhesive layer at the time when two members, one or more of which are made of a fiber-reinforced resin composite, are bonded to each other via the adhesive layer. Therefore, by applying a technique in the disclosure to the structure that constitutes the vehicle body structure, an adhesive strength can be effectively increased. It is noted that the bonded structure 10 to which the technique of the disclosure is applicable is not limited to the structure that constitutes the vehicle body structure, and may be various structures manufactured by bonding two members, one or more of which are made of the fiber-reinforced resin composite.

As illustrated in FIG. 1, the bonded structure 10 illustrated is manufactured by bonding, via an adhesive layer 15, a first member 11 made of the fiber-reinforced resin composite and a second member 13 also made of the fiber-reinforced resin composite. A layer thickness of the adhesive layer 15 is controlled to be, for example, 1 mm or less to secure a desired adhesive strength. The first member 11 and the second member 13 both have a three-dimensional shape having an L shape in cross-section and the bonded structure 10 obtained by bonding the first member 11 and the second member 13 has a three-dimensional shape having an L shape in cross-section including a bend 14. When the bonded structure 10 having the three-dimensional shape and including the bend 14 is manufactured by bonding the first member 11 and the second member 13, it is difficult to control bonded surfaces of the first member 11 and the second member 13 such that a thickness of the adhesive layer 15 between the first member 11 and the second member 13 is uniform.

For example, as illustrated in FIG. 9, in a case in which bonded surfaces of a first member 91 and a second member 93 are distorted, a distance between the first member 91 and the second member 93 varies depending on a position when the first member 91 and the second member 93 are bonded to each other by an adhesive. Therefore, in order for an adhesive layer 95 to have an at least minimum layer thickness, glass beads 97 having a relatively large diameter is to be selected on the assumption of an error range in which the distance between the first member 91 and the second member 93 is maximum. However, since it is difficult to control a position at which the glass bead 97 is disposed, when the glass bead 97 is disposed at a position at which the distance between the first member 91 and the second member 93 is small, a region where a layer thickness D of the adhesive layer 95 is increased consequently is generated, which leads to reduction in the adhesive strength.

In the embodiment, the adhesive layer 15 includes first regions 21 having a relatively large layer thickness D1 and second regions 22 having a relatively small layer thickness D2. Each of the first regions 21 having the relatively large layer thickness D1 is provided at a position distant from the bend 14. The second region 22 having the relatively small layer thickness D2 is provided at a position closer to the bend 14 than the first region 21 and in a region including the bend 14. Accordingly, the second regions 22 of the adhesive layer 15 are disposed between the first regions 21 in an entire bonded structure 10.

In an example illustrated in FIGS. 1 and 2, since a thickness of the second member 13 located in the first regions 21 is smaller than a thickness of the second member 13 located in the second regions 22, the layer thickness D1 of the first regions 21 of the adhesive layer 15 is larger than the layer thickness D2 of the second regions 22. In the embodiment, the second member 13 is made of the fiber-reinforced resin composite molded by laminating fiber-reinforced resin sheets and melting resins. Further, since the number of laminated fiber-reinforced resin sheets located in the second regions 22 is larger than the number of laminated fiber-reinforced resin sheets located in the first regions 21, the thickness of the second member 13 located in the first regions 21 is smaller than the thickness of the second member 13 located in the second regions 22. The number of the laminated fiber-reinforced resin sheets located in the second regions 22 may be larger than the number of the laminated fiber-reinforced resin sheets located in the first regions 21 by one or more, and a difference in the number of the laminated fiber-reinforced resin sheets is not limited in one example. However, when the difference in the number of the laminated fiber-reinforced resin sheets is fairly large, a strength of the bonded structure 10 may be affected, and therefore, the difference in the number of the laminated fiber-reinforced resin sheets is set as small as possible in some embodiments.

A glass bead 17 in contact with the first member 11 and the second member 13 is provided in the first regions 21 of the adhesive layer 15. The glass bead 17 serves as a spacer defining a layer thickness of the adhesive layer 15 in the first regions 21. On the other hand, no glass bead 17 is provided in the second regions 22 of the adhesive layer 15. As described above, the second regions 22 of the adhesive layer 15 are disposed between the first regions 21. Therefore, since the glass bead 17 is provided in the first regions 21 on both ends, the adhesive layer 15 can be formed at a predetermined layer thickness in each of the first regions 21 and the second regions 22 even when no glass bead 17 is provided in the second regions 22.

Even when it is difficult to control the bonded surfaces of the first member 11 and the second member 13 and the layer thickness of the adhesive layer 15 varies, the layer thickness of the adhesive layer 15 can be controlled by the glass bead 17 provided in the first regions 21. Since the layer thickness D2 of the second regions 22 is smaller than the layer thickness D1 of the first regions 21, an adhesive strength of the second regions 22 including the bend 14 can be equal to or higher than an adhesive strength of the first regions 21, and reduction in an adhesive strength in the vicinity of the bend 14 where stress is likely to be concentrated can be limited.

### 1-2. Application Example

FIG. 3 illustrates an application example of the bonded structure 10 according to the embodiment.

When the glass bead 17 is mixed with the adhesive layer 15, a crack may occur in the adhesive layer 15 starting from an interface between the adhesive, which is an organic material, and the glass bead 17, which is an inorganic material (see a crack 99 in FIG. 9). Since the crack occurs in the adhesive layer 15, a bonding strength between the first member 11 and the second member 13 is reduced, and the durability or reliability of the bonded structure 10 is reduced.

In response to the above problem, in the application example, a destruction preventing member 19, which is made of the organic material and is in contact with the first member 11 and the second member 13, is provided in the adhesive layer 15 closer to the second regions 22 than the glass bead 17 provided in the first regions 21 of the adhesive layer 15. The destruction preventing member 19 extends along a boundary between the first regions 21 and the second regions 22. That is, the glass bead 17 is not present in a region on a second region 22 side surrounded by the destruction preventing members 19. As long as the destruction preventing member 19 is located at a position closer to the second regions 22 than the glass bead 17, the destruction preventing member 19 may be provided in the first regions 21 having a large layer thickness or may be provided in the second regions 22 having a small layer thickness.

The destruction preventing member 19 made of the organic material has high compatibility with the adhesive also made of the organic material. Thus, the crack is less likely to occur starting from the interface between the destruction preventing member 19 and the adhesive. Therefore, the crack can be limited from occurring in the adhesive layer 15 in a region including the second regions 22 surrounded by the destruction preventing members 19, and reduction in a bonding strength between the first member 11 and the second member 13 can be limited.

The destruction preventing member 19 is in contact with the first member 11 and the second member 13. Therefore, as illustrated in FIG. 4, even when a crack 25 occurs starting from the interface between the glass bead 17 and the adhesive, the crack 25 can be limited from extending to the second region 22 side. Therefore, the reduction in the adhesive strength in the vicinity of the bend 14 where the stress is likely to be concentrated can be further effectively limited.

Since the destruction preventing members 19 are disposed to surround the second regions 22, when the adhesive is applied at the time of manufacturing, a region to which an adhesive mixed with the glass bead 17 is applied and a region to which an adhesive not mixed with the glass bead 17 is applied can be easily distinguished. Therefore, the glass bead 17 can be limited from being erroneously disposed in the second regions 22.

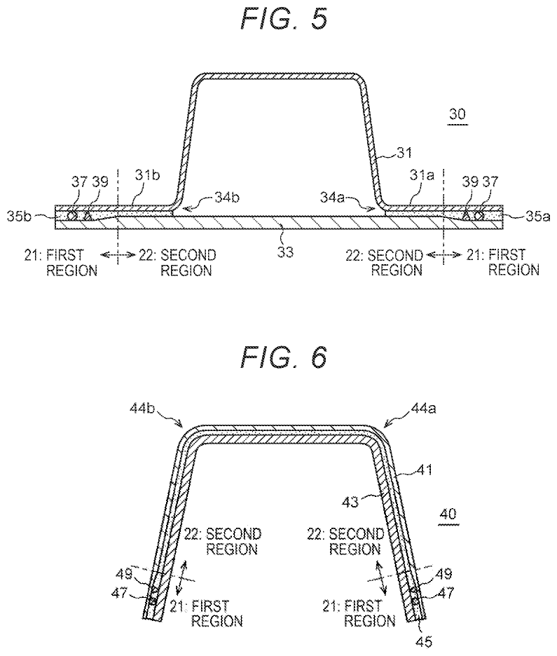

In the above embodiment, the bonded structure 10 having the L shape in cross section is used as an example, and a shape of the bonded structure 10 is not limited to the L shape in cross section. For example, as illustrated in FIG. 5, a bonded structure 30 may be a bonded structure obtained by bonding flanges 31a and 31b of a first member 31 having a hat shape in cross section and a second member 33 having a flat plate shape. In this case, the second regions 22 of adhesive layers 35a and 35b that bond the respective flanges 31a and 31b and the second member 33 are provided at positions on a bend 34a side and a bend 34b side. The bends 34a and 34b are coupled to the respective flanges 31a and 31b, and the first regions 21 are provided at positions distant from the bends 34a and 34b, respectively. Therefore, the second regions 22 of the adhesive layers 35a and 35b are disposed between the first regions 21 of the adhesive layers 35a and 35b.

In the bonded structure 30 manufactured as described above, since glass beads 37 are provided in the first regions 21 on both ends, the adhesive layers 35a and 35b can be formed at a predetermined layer thickness in each of the first regions 21 and the second regions 22 even when the glass beads 37 are not provided in the second regions 22. Even when it is difficult to control bonded surfaces of the first member 31 and the second member 33 and a thickness of the adhesive layers 35a and 35b varies, the thickness of the adhesive layers 35a and 35b can be controlled by the glass beads 37 provided in the first regions 21. Since a layer thickness of the second regions 22 is smaller than a layer thickness of the first regions 21, an adhesive strength of the second regions 22 on the bends 34a and 34b sides can be equal to or higher than an adhesive strength of the first regions 21, and reduction in an adhesive strength in the vicinity of the bends 34a and 34b where the stress is likely to be concentrated can be limited.

Destruction preventing members 39 are provided in the respective adhesive layers 35a and 35b closer to the second regions 22 than the glass beads 37 provided in the first regions 21 of the adhesive layers 35a and 35b. The destruction preventing members 39 are made of the organic material and are in contact with the first member 31 and the second member 33. Therefore, the crack can be limited from occurring in the adhesive layers 35a and 35b in regions including the second regions 22 surrounded by the destruction preventing members 39, and reduction in a bonding strength between the first member 31 and the second member 33 can be limited. Since the destruction preventing members 39 surround the second regions 22, the glass beads 37 can be limited from being erroneously disposed in the second regions 22.

As illustrated in FIG. 6, a bonded structure 40 may be a bonded structure obtained by bonding a first member 41 and a second member 43, both of which have a U shape in cross section. In this case, the second regions 22 of an adhesive layer 45 that bonds the first member 41 and the second member 43 are provided at respective positions on two bends 44a and 44b sides, and the first regions 21 are provided at positions on both ends distant from the bends 44a and 44b, respectively. Therefore, the second regions 22 of the adhesive layer 45 are disposed between the first regions 21.

In the bonded structure 40 manufactured as described above, since glass beads 47 are provided in the respective first regions 21 on both ends, the adhesive layer 45 can be formed at a predetermined layer thickness in each of the first regions 21 and the second regions 22 even when the glass beads 47 are not provided in the second regions 22. Even when it is difficult to control bonded surfaces of the first member 41 and the second member 43 and a thickness of the adhesive layer 45 varies, the thickness of the adhesive layer 45 can be controlled by the glass beads 47 provided in the first regions 21. Since the layer thickness of the second regions 22 is smaller than the layer thickness of the first regions 21, an adhesive strength of the second regions 22 on the bends 44a and 44b sides can be equal to or higher than an adhesive strength of the first regions 21, and reduction in an adhesive strength in the vicinity of the bends 44a and 44b where the stress is likely to be concentrated can be limited.

Destruction preventing members 49 are provided in the adhesive layer 45 closer to the second regions 22 than the glass beads 47 provided in the first regions 21 of the adhesive layer 45. The destruction preventing members 49 are made of the organic material and are in contact with the first member 41 and the second member 43. Therefore, the crack can be limited from occurring in the adhesive layer 45 in a region including the second regions 22 surrounded by the destruction preventing members 49, and reduction in a bonding strength between the first member 41 and the second member 43 can be limited. Since the destruction preventing members 49 surround the second regions 22, the glass beads 47 can be limited from being erroneously disposed in the second region 22.

### 2. Manufacturing Method of Fiber-Reinforced Resin Bonded Structure

Next, an example of the manufacturing method of the fiber-reinforced resin bonded structure according to the embodiment will be described.

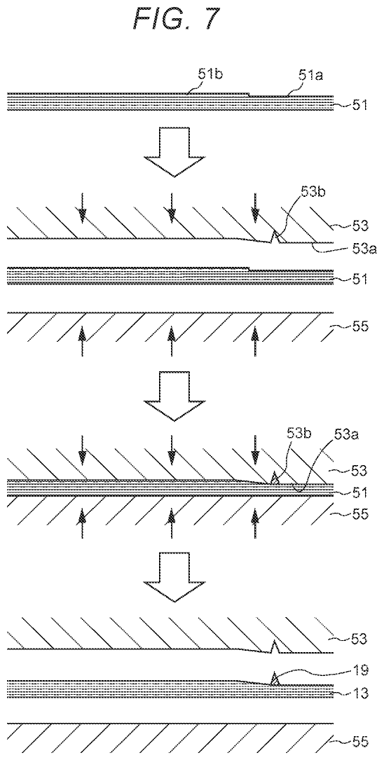

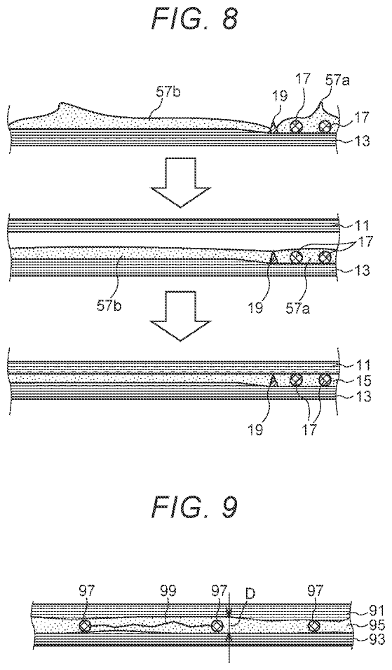

FIGS. 7 and 8 illustrate examples of the manufacturing method of the fiber-reinforced resin bonded structure 10 according to the embodiment. FIG. 7 illustrates a manufacturing process of the second member 13 of the fiber-reinforced resin bonded structure 10 illustrated in FIG. 1, and FIG. 8 illustrates a process of bonding the first member 11 and the second member 13. The views illustrated in FIGS. 7 and 8 are enlarged schematic views simply illustrating a part corresponding to the region X surrounded by an alternate long and short dash line in the fiber-reinforced resin bonded structure 10 illustrated in FIG. 1.

As illustrated in FIG. 7, a fiber-reinforced resin laminate 51 is formed by laminating uncured fiber-reinforced resin sheets. The number of the fiber-reinforced resin sheets is set in accordance with a size of the second member 13 to be formed. The fiber-reinforced resin sheet is, for example, a sheet including continuous fibers impregnated with a matrix resin, and the fiber-reinforced resin sheet may include short fibers in addition to the continuous fibers. Examples of a usable fiber typically include carbon fibers, and may include other fibers or a combination of fibers.

A thermoplastic resin or a thermosetting resin is used as the matrix resin of the fiber-reinforced resin sheet. Examples of the thermoplastic resin include a polyethylene resin, a polypropylene resin, a polyvinyl chloride resin, an acrylonitrile-butadiene-styrene copolymer synthetic resin (ABS resin), a polystyrene resin, an acrylonitrile-styrene copolymer synthetic resin (AS resin), a polyamide resin, a polyacetal resin, a polycarbonate resin, a polyester resin, a polyphenylene sulfide (PPS) resin, a fluororesin, a polyetherimide resin, a polyetherketone resin, and a polyimide resin.

One or a mixture of two types or more of the thermoplastic resins can be used as the matrix resin. Alternatively, the matrix resin may be a copolymer of these thermoplastic resins. When a mixture of the thermoplastic resins is used, a compatibilizer may be added to the mixture. Furthermore, a fire retardant such as a bromine-based fire retardant, a silicon-based fire retardant, or red phosphorus may be added to the thermoplastic resin.

Examples of the thermosetting resin include an epoxy resin, an unsaturated polyester resin, a vinyl ester resin, a phenol resin, a polyurethane resin, and a silicon resin. One or a mixture of two types or more of the thermosetting resins can be used as the matrix resin. When these thermosetting resins are used, a curing agent and a reaction accelerator may be added appropriately to the thermosetting resin.

When the fiber-reinforced resin laminate 51 is formed, the number of the laminated fiber-reinforced resin sheets in a region 51b corresponding to the second region 22 of the adhesive layer 15 to be formed is larger than the number of the laminated fiber-reinforced resin sheets in a region 51a corresponding to the first region 21. The number of the laminated fiber-reinforced resin sheets in the region 51b corresponding to the second region 22 may be larger than the number of the laminated fiber-reinforced resin sheets in the region 51a corresponding to the first region 21 by one or more, and a difference in the number of the laminated fiber-reinforced resin sheets may be set in consideration of variations in the thickness of the adhesive layer 15 to be formed and the smoothness of the bonded surfaces of the first member 11 and the second member 13.

Then, the formed fiber-reinforced resin laminate 51 is put into molding dies 53 and 55, and heated while being pressurized, thereby molding the second member 13 made of the fiber-reinforced resin composite. At this time, in a molding surface 53a of the molding die 53 that molds a surface (an upper surface in FIG. 7) serving as a bonded surface to be bonded to the first member 11, a part corresponding to the first region 21 is located closer to the molding die 55 than a part corresponding to the second region 22. Therefore, in the second member 13 to be molded, a thickness of the part corresponding to the first region 21 is smaller than a thickness of the part corresponding to the second region 22.

A groove 53b is provided in the molding surface 53a of the molding die 53. The groove 53b is provided at a position corresponding to a position where the destruction preventing member 19 is disposed. Therefore, when the fiber-reinforced resin laminate 51 is pressurized, the groove 53b is filled with resins in a molten state that constitute the fiber-reinforced resin sheet. For example, when the second member 13 is molded using the fiber-reinforced resin sheet including the thermosetting resin and the continuous fibers, hot press molding may be used. Alternatively, when the second member 13 is molded using the fiber-reinforced resin sheet including the thermosetting resin and the continuous fibers, for example, autoclave molding may be used.

A depth of the groove 53b in the molding surface 53a of the molding die 53 is designed to be approximately the same as the layer thickness of the first region 21 of the adhesive layer 15 to be formed or a diameter of the glass bead 17 disposed in the first region 21. Accordingly, by molding the second member 13 using the molding die 53, the destruction preventing member 19 made of the organic material can be simultaneously formed.

Although illustration of a molding method of the first member 11 is omitted, basically, a fiber-reinforced resin laminate including laminated fiber-reinforced resin sheets is molded by the same molding method as the second member 13 using a desired molding die, and the number of the laminated fiber-reinforced resin sheets is set in accordance with a thickness of the first member 11 to be molded.

Then, as illustrated in FIG. 8, after adhesives 57a and 57b are applied onto the second member 13, the adhesive is cured and the first member 11 and the second member 13 are bonded to each other in a state in which the first member 11 is superimposed on the second member 13. At this time, the glass beads 17 are mixed with the adhesive 57a applied at a position closer to a region corresponding to the first region 21 than the destruction preventing member 19. On the other hand, the glass bead 17 is not mixed with the adhesive 57b applied at a position closer to a region corresponding to the second region 22 than the destruction preventing member 19. Since the destruction preventing member 19 is provided, a region to which the adhesive 57a is applied and a region to which the adhesive 57b is applied can be easily distinguished, and the glass bead 17 can be limited from being disposed in the region corresponding to the second region 22.

For example, a glass bead having a diameter of 1 mm or less is used as the glass bead 17. Accordingly, the layer thickness of the adhesive layer 15 in the first region 21 is defined by the diameter of the glass bead 17, and the layer thickness of the adhesive layer 15 in the second region 22 is smaller than the layer thickness of the adhesive layer 15 in the first region 21. Therefore, the adhesive layer 15 can be formed at a predetermined layer thickness in each of the first region 21 and the second region 22. Since the layer thickness of the second region 22 is smaller than the layer thickness of the first region 21, the reduction in the bonding strength of the region including the bend 14 where the stress is likely to be concentrated can be limited.

The destruction preventing member 19, which is formed on the second member 13 and has a height substantially the same as the layer thickness of the first region 21 of the adhesive layer 15 and the diameter of the glass bead 17 disposed in the first region 21, is also in contact with the first member 11. Therefore, even when the crack occurs starting from the interface between the glass bead 17 and the adhesive, the crack can be limited from extending to a second region side by the destruction preventing member 19.

While the embodiment of the disclosure is described in detail with reference to the accompanying drawings, the disclosure is not limited to the embodiment. It is evident that a person having ordinary skill in the art to which the disclosure pertains can conceive of examples of various modifications or revisions within the scope of the technical concept set forth in the claims. It is understood that these modifications or revisions naturally fall in the technical range of the disclosure. Furthermore, modes of combinations of the embodiment with the modified examples naturally fall in the technical scope of the disclosure.

For example, in the fiber-reinforced resin bonded structure 10 according to the above embodiment, both the first member 11 and the second member 13 are made of the fiber-reinforced resin composite, and the disclosure is not limited to the embodiment. One or more of the first member 11 and the second member 13 may be a metal member or the like. Therefore, the technique of the disclosure can also be applied to, for example, a fiber-reinforced resin bonded structure obtained by bonding the fiber-reinforced resin composite to a reinforcement made of a metal.

In the fiber-reinforced resin bonded structure 10 according to the above embodiment, the layer thickness of the adhesive layer 15 in the first region 21 is larger than the layer thickness of the adhesive layer 15 in the second region 22 by changing the thickness of the second member 13 of the first member 11 and the second member 13, and the disclosure is not limited to the embodiment. The layer thickness of the adhesive layer 15 in the first region 21 may be larger than the layer thickness of the adhesive layer 15 in the second region 22 by changing the thickness of the first member 11 of the first member 11 and the second member 13. The layer thickness of the adhesive layer 15 in the first region 21 may be larger than the layer thickness of the adhesive layer 15 in the second region 22 by changing the thickness of the first member 11 and the thickness of the second member 13.

In the manufacturing method of the fiber-reinforced resin bonded structure 10 according to the above embodiment, the destruction preventing member 19 is formed simultaneously with molding of the second member 13 by providing the groove 53b in the molding surface 53a of the molding die 53 that molds the second member 13, and a method for forming the destruction preventing member 19 is not limited to the embodiment. For example, after the second member 13 that does not include the destruction preventing member 19 is molded, the destruction preventing member 19 made of the organic material in a separate process may be disposed on the second member 13.

The technical scope of the disclosure also covers the following aspects.

In a fiber-reinforced resin bonded structure, one or more of a first member and a second member include a bend, a second region is provided at a position on a bend side, and a first region is provided at a position distant from the bend.

As described above, according to the embodiment of the disclosure, an adhesive strength of a fiber-reinforced resin bonded structure can be improved. The fiber-reinforced resin bonded structure is obtained by bonding a first member and a second member, one or more of the first member and the second member are made of a fiber-reinforced resin composite.

1. A fiber-reinforced resin bonded structure comprising:
a first member;
a second member; and
an adhesive layer that bonds the first member and the second member, wherein
one or both of the first member and the second member are made of a fiber-reinforced resin composite,
the adhesive layer comprises at least one first region having a relatively large layer thickness and a second region having a relatively small layer thickness, and
the at least one first region of the adhesive layer comprises a spacer in contact with the first member and the second member.

2. The fiber-reinforced resin bonded structure according to claim 1, wherein
the spacer is made of an inorganic material, and
the adhesive layer comprises a destruction preventing member disposed closer to the second region than the spacer,
the destruction preventing member is made of an organic material, and
the destruction preventing member is in contact with or coupled to the first member and the second member.

3. The fiber-reinforced resin bonded structure according to claim 2, wherein
the destruction preventing member is a protrusion provided on one or both of the first member and the second member.

4. The fiber-reinforced resin bonded structure according to claim 1, wherein
the one or both of the first member and the second member are made of a fiber-reinforced resin composite comprising laminated fiber-reinforced resin sheets, and
a number of laminated fiber-reinforced resin sheets located in the second region is larger than a number of laminated fiber-reinforced resin sheets located in the at least one first region.

5. The fiber-reinforced resin bonded structure according to claim 1, wherein
the at least one first region comprises first regions, and
the second region of the adhesive layer is disposed between the first regions.
